(19) United States
(12) Patent Application Publication
(10) Pub. No.: US 2026/0072624 A1
(43) Pub. Date: Mar. 12, 2026

(54) METHODS AND PRINTING SYSTEM FOR INTELLIGENTLY HANDLING JOB RENDERING

(71) Applicant: Kyocera Document Solutions Inc., Osaka (JP)

(72) Inventor: Javier A. MORALES, Rochester, NY (US)

(73) Assignee: Kyocera Document Solutions Inc., Osaka (JP)

(21) Appl. No.: 18/829,750

(22) Filed: Sep. 10, 2024

(51) Int. Cl. G06F 3/12

(52) U.S. Cl. CPC G06F 3/121; G06F 3/1265

(57) ABSTRACT

A printing system includes a printing device that receives print jobs. The printing device includes a controller having a raster image processing (RIP) system and a preflight application. The RIP system renders a plurality of pages of a print job. The controller determines that a source page of the plurality of pages includes an error that causes the page to fail to render. The source page is provided to the preflight application. A data file having the source page is opened in the preflight application. The preflight application corrects the error on the source page to generate a corrected page. The corrected page replaces the source page of the plurality of pages of the print job. The corrected page is rendered using the RIP system and printed with the plurality of pages of the print job.

### FIELD OF THE INVENTION

The present invention relates to a printing system and associated methods to render one or more pages of a print job in an intelligent manner to improve overall efficiency for rendering the print job.

### DESCRIPTION OF THE RELATED ART

Modern raster image processors (RIPs) may be robust. Yet, many cases exist in which poorly-prepared portable document format (PDF) files may result in errors when performing RIP operations for a job. As a result, software products in the production print market allow prepress users to preflight jobs in order to detect problems before job submission. These tools also provide functionality to correct PDF file problems that trigger errors when rendering the files.

While these tools are fairly robust and may preserve job integrity, these tools may introduce unexpected changes to the PDF contents. In addition, when these tools are introduced into the workflow, they are used in the most optimal manner. For example, the tools may be used on all jobs, even those that do not benefit from them. In this instance, the number of corrections is minimal because changing the PDF file comes with the risk of unintended changes to appearance. Cases exist where jobs will still generate errors when processing.

When jobs generate errors during processing, the operator opens the job in one of these tools and performs corrections on the entire job. This task may be very inefficient for jobs with a large number of pages. That is not particularly efficient as the job must be rendered again in its entirety once the corrections have been applied.

### SUMMARY OF THE INVENTION

A method for managing printing operations is disclosed. The method includes rendering a plurality of pages of a print job using at least one raster image processor (RIP) of a RIP system for a printing device. The method also includes determining at least one first source page of the plurality of pages includes an error that causes the at least one first source page to fail to render using the at least one RIP. The method also includes providing a data file having the at least one first source page to a preflight application. The method also includes opening the data file in the preflight application. The method also includes executing the preflight application to correct the error on the at least one first source page to generate at least one corrected page. The method also includes replacing the at least one first source page of the plurality of pages with the at least one corrected page. The method also includes rendering the at least one corrected page using the at least one RIP of the RIP system.

A method for managing printing operations is disclosed. The method includes rendering a print job having a plurality of pages at a raster image processing (RIP) system for a printing device. The method also includes determining a first source page of the plurality of pages includes an error by the RIP system. The first source page fails to render. The method also includes opening the first source page in a preflight application associated with the printing device. The method also includes correcting the error of the first source pages using the preflight application to generate a first corrected page. The method also includes replacing the first source page with the first corrected page in the plurality of pages. The method also includes rendering the first corrected page by the RIP system.

A printing system is disclosed. The printing system includes a printing device having a raster image processing (RIP) system. The printing system also includes a preflight application. The printing system also includes a processor connected to a memory storing instructions. The processor executes the instructions to perform operations. The operations include rendering a plurality of pages of a print job using at lest one raster image processor (RIP) of the RIP system. The operations also include determining at least one first source page of the plurality of pages includes an error that causes the at least one first source page to fail to render using the at least one RIP. The operations also include providing the at least one first source page to the preflight application. The operations also include opening the data file in the preflight application. The operations also include executing the preflight application to correct the error on the at least one first source page to generate at least one corrected page. The operations also include replacing the at least one first source page of the plurality of pages with the at least one corrected page. The operations also include rendering the at least one corrected page using the at least one RIP of the RIP system.

### BRIEF DESCRIPTION OF THE DRAWINGS

Various other features and attendant advantages of the present invention will be more fully appreciated when considered in conjunction with the accompanying drawings.

FIG. 1 illustrates a printing system for managing jobs according to the disclosed embodiments.

FIG. 2 illustrates a block diagram of components of the printing device for use within the printing system according to the disclosed embodiments.

FIG. 3 illustrates a block diagram of a RIP system for use in processing a job in the printing system according to the disclosed embodiments.

FIG. 4 illustrates a block diagram of an example RIP used within the RIP system according to the disclosed embodiments.

FIG. 5 illustrates a block diagram of the printing system configured to handle rendering errors and error correction according to the disclosed embodiments.

FIG. 6 illustrates another block diagram of the printing system configured to handle rendering errors and error correction according to the disclosed embodiments.

FIG. 7 illustrates a flowchart for handling errors during printing operations according to the disclosed embodiments.

### DETAILED DESCRIPTION OF THE PREFERRED EMBODIMENTS

Reference will now be made in detail to specific embodiments of the present invention. Examples of these embodiments are illustrated in the accompanying drawings. Numerous specific details are set forth in order to provide a thorough understanding of the present invention. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims.

A print job may be composed of a variety of pages. Some of the pages may be simple and rendered at a higher speed compared to the engine speed. Other pages may be complex and take a long time to render. Further, the type of job sent for processing may vary from one job to another. Some of the jobs are required to be printed immediately, while other jobs are only rendered and printed at a later time, or process and hold jobs. Other jobs only may print one copy and hold the remaining copies to be printed on user demand, or a proof and hold job. Other jobs may require multiple copies to be printed. Depending on the type of job, and the difficulty of pages in a job, management of printing operations results in time and storage/space complexity.

The disclosed embodiments provide an opportunity to more intelligently handle rendering errors in order to optimize both error correction and job rendering. The disclosed system takes advantage of the page-independent nature of modern page description languages (PDLs), such as DSC PostScript and PDFs, in order to improve overall efficiency when there are rendering issues.

The disclosed embodiments provide a printing system that provides intelligent job failure handling. Jobs are received and processed by the digital front end (DFE), or controller, of a printing device in the normal manner. In other words, a PDL, or PDF, is received and individual pages, or a range of pages, are distributed to individual RIP instances. If there are no errors then jobs process normally as is common with all production print RIP systems.

If, however, an error occurs in processing some of the pages, then the disclosed embodiments may fail the page itself but not the job. The error information will be associated with the specific page. The RIP may have a status for individual rendered pages. The disclosed embodiments will continue processing additional pages and setting status for each page individually based on whether the page succeeds or fails to render.

Once the job is completed processing at the RIP system, the disclosed embodiments should have a set of rendered pages and a set of pages that failed to render due to one or more errors. The disclosed embodiments allow the operator to download the pages that failed to render. The operator may download the pages that failed to render one at a time or they may download a PDL that is composed of the failed pages. If the operator downloads individual files for each page, then the disclosed embodiments should embed metadata in these pages so that the source PDL page can be identified at a later time. If the operator downloads a single file with all pages that failed to render, then the disclosed embodiments will retain information about the correlation between the error PDL pages and the source pages in the PDL of the job. Once the operator downloads the files then he/she may use the preflight application of choice to correct errors in the files.

The operator may upload the files or file back into the job. If the operator downloaded an individual file for each page, then the disclosed embodiments may use the metadata that is embedded into the PDL to determine which job page to replace with the newly uploaded page. If the operator downloaded a PDL with all the error pages, then the disclosed embodiments may split the uploaded PDLs into single pages and replace the source pages in the PDL of the job. The disclosed embodiments then may render the newly uploaded pages. If the operator uploads pages one at a time, then the disclosed embodiments may render pages as they are uploaded. If the uploaded pages still have rendering errors, then the disclosed embodiments may repeat the above process until all pages have been rendered. Once all pages are rendered, the disclosed embodiments may print the job, or otherwise handle the job, in a normal manner.

In some embodiments, the preflight tools may be integrated directly in the DFE. In this case, the operator will have the option to “open” the error PDL page or pages directly into the preflight application. Alternatively, the operator may be given the option to apply defined preflight corrections to the job. The disclosed embodiments then may apply these corrections only to the error pages in the PDL. Thus, the disclosed embodiments may provide for multiple possible implementations of error correction. These implementations may include downloading error PDL pages, “opening” error PDL pages in a preflight tool that is part of the DFE, and sending error PDL pages to an integrated and automated correction process.

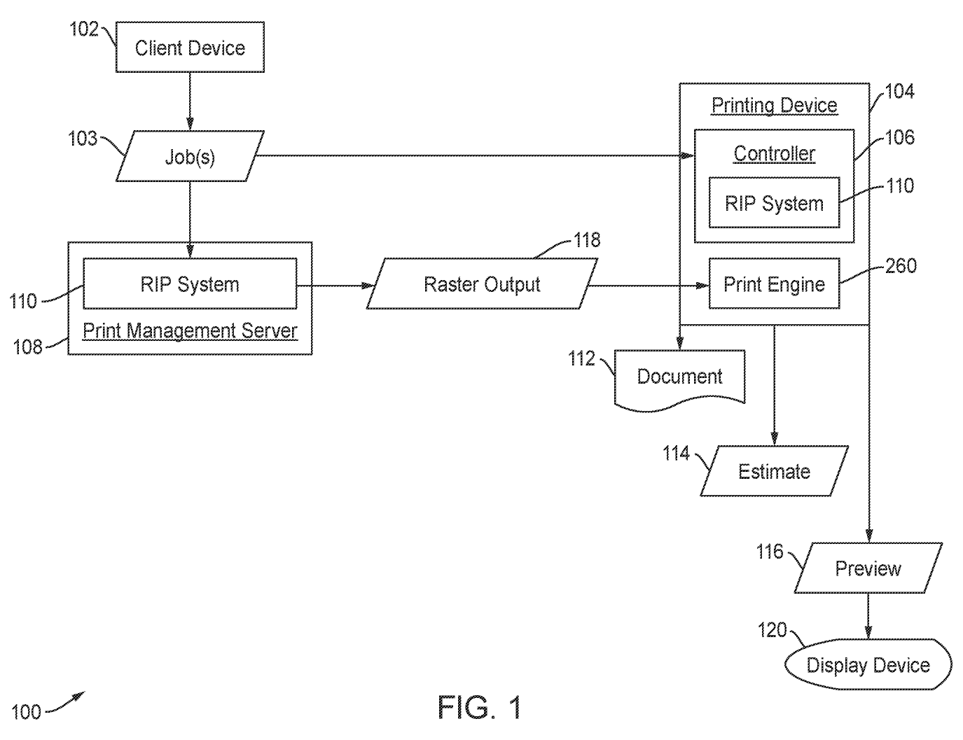

FIG. 1 depicts a printing system 100 for managing jobs using RIP system 110 according to the disclosed embodiments. Printing system 100 may be located in a print shop or other environment suitable for production printing operations. Printing system 100 includes one or more printing devices 104 that receive jobs 103 from one or more client terminals 102.

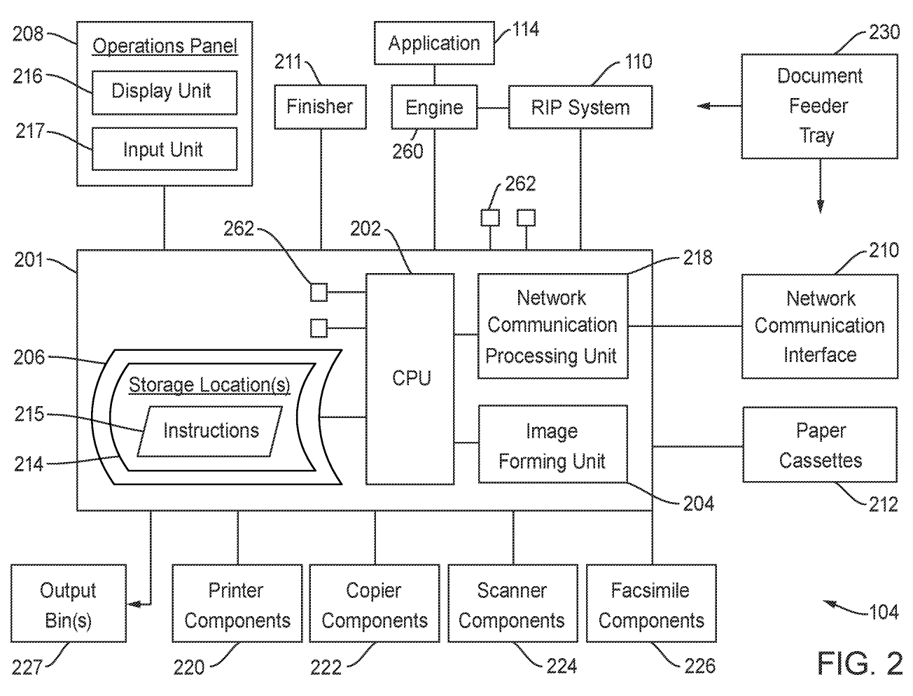

Printing device 104 receives jobs through printing system 100, such as job 103. In some embodiments, job 103 is a print job. After processing job 103, printing device 104 may print or produce document 112 in a paper or media specified by the print job. Printing device 104 is disclosed in greater detail in FIG. 2. Printing device 104 also includes a controller, or digital front end (DFE), 106, which facilitates processing job 103. Controller 106 also includes RIP system 110, which is disclosed in greater detail below.

For example, controller 106 may use RIP system 110 to convert bitmap images, vector graphics, fonts, and the like associated with pages in job 103 to bitmap/rasterized representations of the pages, such as C, M, Y, and K pixels. The sum of the values of pixels of a particular color in the rasterized pages may be proportional to the amount of consumables used by printing device 104 to print that color. RIP system 110 may rasterize pages of job 103 according to various image rasterization settings. For example, these image rasterization parameters may include calibration curves, paper definitions, ICC profiles, spot color definitions, TRCs, color conversion settings, colorant limits for ink or toner, rendering intent, K preservation, CGR level, max colorant densities, print margins, halftones, and the like.

Print engine 260 also is included with printing device 104. Printing device 104 may correspond to an industrial printing device capable of printing thousands of pages in an hour. Printing device 104 may be ink-based, toner-based, or both. Print engine 260 may include various parameters that can control the operation of printing device 104. For example, these settings may include printing device maintenance settings that control or effect head cleaning intervals, head clogging prevention intervals, and the like of printing device 104. Print engine 260 receives raster output from RIP system 110 in printing device 104 to print document 112 based on job 103.

Printing system 100 receives job 103 and may route it directly to printing device 104. Alternatively, printing system 100 may route job 103 to print management server 108. Print management server 108 may seek to offload processing of job 103 from controller 106 of printing device 104. This feature may be desirable if controller 106 does not have the processing capacity to handle jobs 103 in a production printing environment. Thus, print management server 108 also may include RIP system 110 that can provide raster output 118 directly to print engine 260 of printing device 104. These embodiments allow controller 106 to offload processing in order to handle other operations. Further, updates to RIP system 110 may occur at print management server 108 prior to any updates to RIP system 110 in printing device 104.

Job 103 is not always a print job that produces document 112. In some embodiments, job 103 may be an estimation job or a preview job. RIP system 110 determines which type of job is job 103 and configures itself accordingly. For an estimation job, RIP system 110 configures RIPs to process job 103 without impacting print processing within controller 106. The estimation RIPs process job 103 to provide an ink or toner estimate 114. Estimate 114 may be provided to an operator without engaging print engine 260.

For a preview job, RIP system 110 configures RIPs to process job 103 to quickly generate a lower resolution output as preview 116. Preview 116 may be a lower resolution output as compared to document 112 and estimate 114. Preview 116 is provided to the operator to review. Preview 116 may be provided to display device 120 for the operator to review and interact with using an interface. Display device 120 may be a separate device from client device 102 and printing device 104. In other embodiments, display device 120 may be incorporated within client device 102 or printing device 104.

RIP system 110 may be a smart system that enables optimal processing by using page complexity determination to handle a variety of jobs 103. Different jobs received at printing device 104 or print management server 108 result in different output, such as document 112, estimate 114, or preview 116. The RIP instances within RIP system 110 are configured according to the type of job 103 is received.

FIG. 2 depicts a block diagram of components of printing device 104 according to the disclosed embodiments. The architecture shown in FIG. 2 may apply to any multi-functional printing device or image forming apparatus that performs various functions, such as printing, scanning, storing, copying, and the like within printing system 100. As disclosed above, printing device 104 may send and receive data from client device 102, print management server 108, if a separate device, and other devices within system 100.

Printing device 104 includes a computing platform 201 that performs operations to support these functions. Computing platform 201 includes a computer processing unit (CPU) 202, an image forming unit 204, a memory unit 206, and a network communication interface 210. Other components may be included but are not shown for brevity. Printing device 104, using computing platform 201, may be configured to perform various operations, such as scanning, copying, printing, receiving or sending a facsimile, or document processing. As such, printing device 104 may be a printing device or a multi-function peripheral including a scanner, and one or more functions of a copier, a facsimile device, and a printer. To provide these functions, printing device 104 includes printer components 220 to perform printing operations, copier components 222 to perform copying operations, scanner components 224 to perform scanning operations, and facsimile components 226 to receive and send facsimile documents. CPU 202 may issue instructions to these components to perform the desired operations.

Printing device 104 also includes a finisher 211 and one or more paper cassettes 212. Finisher 211 includes rotatable downstream rollers to move papers with an image formed surface after the desired operation to a tray. Finisher 211 also may perform additional actions, such as sorting the finished papers, binding sheets of papers with staples, doubling, creasing, punching holes, folding, and the like.

Paper cassettes 212 supply paper to various components 220, 222, 224, and 226 to create the image formed surfaces on the papers. Paper cassettes 212 also may be known as paper trays. Paper cassettes 212 may include papers having various sizes, colors, composition, and the like. Papers or media within paper cassettes 212 may be considered “loaded” onto printing device 104. The information for printing these papers may be captured in a paper catalog stored at controller 106. Paper cassettes 212 may be removed to refill as needed. The printed papers from components 220, 222, 224, and 226 are placed within one or more output bins 227. One or more output bins 227 may have an associated capacity to receive finished print jobs before it must be emptied or printing paused. The output bins may include one or more output trays.

Document processor input feeder tray 230 may include the physical components of printing device 104 to receive papers and documents to be processed. Feeder tray also may refer to one or more input trays for printing device 104. A document is placed on or in document processor input feeder tray 230, which moves the document to other components within printing device 104. The movement of the document from document processor input feeder tray 230 may be controlled by the instructions input by the user. For example, the document may move to a scanner flatbed for scanning operations. Thus, document processor input feeder tray 230 provides the document to scanner components 224. As shown in FIG. 2, document processor input feeder tray 230 may interact with print engine 260 to perform the desired operations.

Memory unit 206 includes memory storage locations 214 to store instructions 215. Instructions 215 are executable on CPU 202 or other processors associated with printing device 104, such as any processors within components 220, 222, 224, or 226. Memory unit 206 also may store information for various programs and applications, as well as data specific to printing device 104. For example, a storage location 214 may include data for running an operating system executed by computing platform 201 to support the components within printing device 104. According to the disclosed embodiments, memory unit 206 may store the tokens and codes used in performing the deferral operations for printing device 104.

Memory unit 206 may comprise volatile and non-volatile memory. Volatile memory may include random access memory (RAM). Examples of non-volatile memory may include read-only memory (ROM), flash memory, electrically erasable programmable read-only memory (EEPROM), digital tape, a hard disk drive (HDD), or a solid-state drive (SSD). Memory unit 206 also includes any combination of readable or writable volatile memories or non-volatile memories, along with other possible memory devices.

Computing platform 201 may host one or more processors, such as CPU 202. These processors are capable of executing instructions 215 stored at one or more storage locations 214. By executing these instructions, the processors cause printing device 104 to perform various operations. The processors also may incorporate processing units for specific purposes, such as application-specific integrated circuits (ASICs) and field programmable gate arrays (FPGAs). Other processors may be included for executing operations particular to components 220, 222, 224, and 226. In other words, the particular processors may cause printing device 104 to act as a printer, copier, scanner, and a facsimile device.

Printing device 104 also includes an operations panel 208, which may be connected to computing platform 201. Operations panel 208 may include a display unit 216 and an input unit 217 for facilitating interaction with a user to provide commands to printing device 104. Display unit 216 may be any electronic video display, such as a liquid crystal display (LCD). Input unit 217 may include any combination of devices that allow users to input information into operations panel 208, such as buttons, a touch screen, a keyboard or keypad, switches, dials, and the like. Preferably, input unit 217 includes a touch-screen digitizer overlaid onto display unit 216 that senses touch to receive inputs from the user. By this manner, the user interacts with display unit 216. Using these components, one may enter codes or other information into printing device 104.

Display unit 216 also may serve as to display results from print management server 108. Display unit 216 may act as display device 120 for displaying preview 116 after it is generated by RIP system 110.

Printing device 104 also includes network communication processing unit 218. Network communication processing unit 218 may establish a network communication using network communication interface 210, such as a wireless or wired connection with one or more other image forming apparatuses or a network service. CPU 202 may instruct network communication processing unit 218 to transmit or retrieve information over a network using network communication interface 210. As data is received at computing platform 201 over a network, network communication processing unit 218 decodes the incoming packets and delivers them to CPU 202. CPU 202 may act accordingly by causing operations to occur on printing device 104. CPU 202 also may retrieve information stored in memory unit 206, such as settings for printing device 104.

Printing device 104 also includes print engine 260, as disclosed above. Engine 260 may be a combination of hardware, firmware, or software components that act accordingly to accomplish a task. For example, engine 260 is comprised of the components and software to print a document. It may receive instructions from computing platform 201 after user input via operations panel 208. Alternatively, engine 260 may receive instructions from other attached or linked devices.

Engine 260 manages and operates the low-level mechanism of the printing device engine, such as hardware components that actuate placement of ink or toner onto paper. Engine 260 may manage and coordinate the half-toner, toner cartridges, rollers, schedulers, storage, input/output operations, and the like. RIP system 100 that interprets the page description languages (PDLs) would transmit and send instructions down to the lower-level engine 260 for actual rendering of an image and application of the ink onto paper during operations on printing device 104. RIP system 110 may be located in controller 106, as disclosed above. Alternatively, RIP system 110 may be located on print management server 108 and directly communicates with print engine 260.

Printing device 104 may include one or more sensors 262 that collect data and information to provide to computing platform 201 or CPU 202. Each sensor 262 may be used to monitor certain operating conditions of printing device 104. Sensors 262 may be used to indicate a location of a paper jam, failure of hardware or software components, broken parts, operating system problems, document miss-feed, toner level, as well as other operating conditions. Sensors 262 also may detect the number of pages printed or processed by printing device 104. When a sensor 262 detects an operational issue or failure event, it may send a signal to CPU 202. CPU 202 may generate an error alert associated with the problem. The error alert may include an error code.

Some errors have hardware-related causes. For example, if a failure occurred in finisher 211, such as a paper jam, display unit 216 may display information about the error and the location of the failure event, or the finisher. In the instance when the paper jam occurs in paper cassettes 212, display unit 216 displays the information about the jam error as located in one of the paper cassettes.

Some errors have a type of firmware-related cause. For example, network communication processing unit 218 may cause a firmware or software error. Display unit 216 may display the firmware-related error, any applicable error codes, and provide recommendations to address the error, such as reboot the device.

Memory unit 206 may store the history of failure events and occurred errors with a timestamp of each error. Printing device 104 communicates with other devices within system 100 via network communication interface 210 by utilizing a network protocol, such as the ones listed above. In some embodiments, printing device 104 communicates with other devices within system 100 through REST API, which allows the server to collect data from multiple devices within system 100. REST API and SOAP are application protocols used to submit data in different formats, such as files, XML messages, JSON messages, and the like. By utilizing applicable network communication protocols and application protocols, printing device 104 submits and receives data from client device 102 and print management server 108 as well as other printing devices within printing system 100.

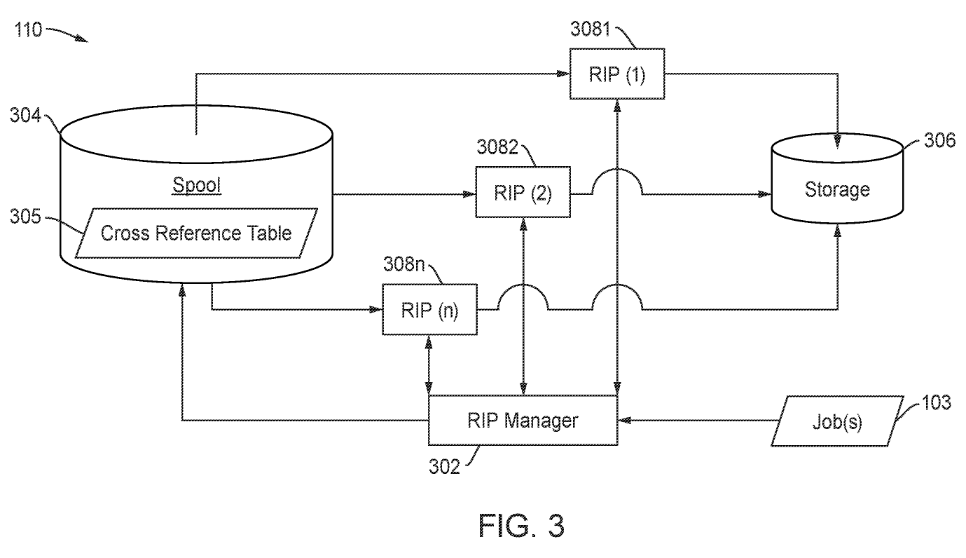

FIG. 3 depicts a block diagram of RIP system 110 for use in processing job 103 in printing system 100 according to the disclosed embodiments. As disclosed above, RIP system 110 may be located in controller 106 of printing device 104. It also may be located on print management server 108 such that it communicates directly with print engine 260 of printing device 104.

RIP system 100 include RIP manager 302 and RIP instances RIP 3081, RIP 3082, and RIP 308n. A RIP instance may be a RIP configured by RIP manager 302 to process job 103. A RIP instance may be a standard RIP, a high performance RIP, a very high performance RIP, a preview RIP, an estimation RIP, or a failover RIP. All RIP instances and RIP manager 302 operate in parallel to each other.

RIP manager 302 performs a variety of operations. It may contain multiple subunits that operate in parallel to perform the variety of operations, like spooling job 103, managing job 103, managing pages or segments of job 103, managing RIP instances 3081, 3082, and 308n, managing drives, determining the PDL type of job 103, distributing pages of segments of job 103 to the RIP instances, serializing pages or segments of job 103, sending notifications within printing device 104 or print management server 108.

RIP manager 302 may receive job 103 through printing system 100. Job 103 may be received from client device 102 via internet protocols within printing system 100. Job 103 may be spooled by RIP manager 302 and stored in spool drive 304. Spool drive 304 may be a configurable drive. RIP manager 302 determines the PDL type of job 103. It then creates a cross reference table 305 in spool drive 304, which acts as a shared memory with RIP instances 3081, 3082, and 308n. RIP manager 302 also may create print ticket information in spool drive 304.

RIP manager 302 analyzes job 103 to determine which type of job it is. It uses this information to determine the number of RIPs and type of RIPs to be used in processing job 103. Depending on the type of job, RIP manager 302 configures RIP instances 3081, 3082, and 308n. A configuration operation may create a RIP having a certain number of renderers. For example, RIP instance 3081 may be a standard RIP having a normal number of renderers, such as 4. RIP instance 3082 may be a high performance RIP that has a higher number of renders, such as 6. RIP manager 302 configures the RIP instances accordingly to process job 103.

RIP manager 302 then distributes pages or segments of job 103 to RIP instances 3081, 3082, and 308n. Job 103 may be a print job that is split into segments or pages for parallel processing. As RIP instance 3082 is a high performance RIP, then it may receive specific pages or segments of job 103. Pages may refer to one or more pages of job 103. Segments of job 103 also may refer to a number of pages or a block of data within job 103. The pages or segments are distributed by front end 302 using inter-process communication.

RIP instances 3081, 3082, and 308n may read cross reference table 305 along with print ticket information and the spooled data for job 103. Each RIP instance then processes the page or segment that it is instructed to by RIP manager 302. The RIP instance may check cross reference table 305 to obtain any instructions in the print ticket information and the data for the page or segment in spool drive 304. RIP instances 3081, 3082, and 308n then parse the data for the page or segment to create metadata from the drawing commands.

The RIP instances render the metadata to storage 306. Storage 306 may store the rendered pages for a print job of job 103. The rendered pages may be stored according to a specific image format, such as the KYOCERA^{TM} Image Format (KIF). The stored pages may then be provided to print engine 260 to print document 112. For jobs 103 that do not require rendered pages, such as previews and estimates, the data generated by the RIP instances may be provided back to front end 302 for further operations.

RIP system 110 provides advantages over conventional RIP systems. RIP manager 302 may control the number of renderers per RIP. It may increase the number to process a page or segment faster. It also may increase the amount of memory allocated to the RIP as faster processing consumes more memory. If processing is to be slower, such as for estimate 114 or preview 116, then the configured RIP should consume less memory. RIP manager 302 manages these requirements through dynamic configuration of the RIPs based on the parameter of job 103.

In some instances, RIP manager 302 may determine that job 103 is not able to be split into pages or segments for parallel processing. Thus, it may configure a RIP instance, such as RIP instance 308n, into a very high performance RIP. The very high performance RIP uses more renderers than the high performance RIP. For example, RIP instances 308n may be configured to use 8 renderers. This feature increases the processing speed of RIP instance 308n. Front end 302 may still use RIP instances 3081 and 3082 for parallel processing on one job 103 while using RIP instance 308n for processing another job 103 that is not able to be broken into pages or segments.

RIP system 110 provides features available due to the parallel processing using dynamically configured RIP instances. RIP system 110 may configure a high performance RIP to improve the first page out time. It also may use differently configured RIPs for different purposes, such a preview RIPs, estimation RIPs, and failover RIPs. RIP system 110 also may configure very high performance RIPs for jobs that cannot be processed in a page or segment parallel manner.

RIP system 110 also provides the ability to change the number of renderers per RIP. RIP system 110 also changes the number of RIP instances based on its workload, which includes shutting down certain types of RIPs in order to launch other types of RIPs. RIP system 100 also processes different kinds of jobs in RIPs with different configurations. RIP system 110 also uses different RIPs with different configurations for different purposes. It configures RIP instances with different imaging pipelines. RIP system 110 also retries failed jobs or job pages in a differently configured RIP instance.

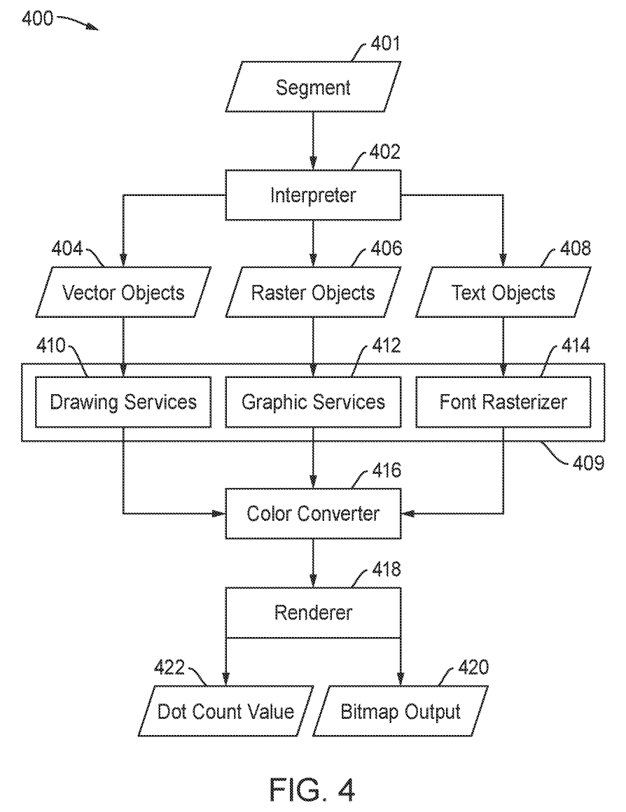

FIG. 4 depicts a block diagram of an example RIP 400 used within RIP system 110 according to the disclosed embodiments. RIP 400 may represent a configuration for RIP instances 3081, 3082, or 308n. RIP 400 may represent the hardware and software configuration used to determine what value each pixel or spot of output should possess, driven by commands from a page description language (PDL). Computer-generated output may be composed of very small spots. RIP 400 converts a vector-based image, or a stored image, into a series of mathematical formulas that describe lines and curves into a pattern of spots needed to generate the output, or raster image. Interpreter 402 converts a job file into a display list, which is then converted into a bitmap output 418 describing a page of the document.

RIP 400 converts text and image data from different file formats including PDF, TIFF, or JPEG into a format that printing device 104 can understand. The process of raster image processing a page implements several steps to be performed, regardless whether the page is submitted as PostScript, PDF, or any other page description language (PDL). In short, RIP 400 may provide interpretation, rasterization, and screening.

Segment 401 may be a job file associated with job 103. Segment 401 may be provided to RIP 400 to convert its code into raster or bitmap code. As disclosed above, front end 302 receives job 103. Front end 302 may split job 103 into segments for parallel processing by the RIP instances. Preferably, segment 401 is a page the document in job 103. RIPs process pages in a parallel manner within RIP system 100. RIP 400 is one of the RIP instances. In other embodiments, segment 401 may be several pages, a graphic design, or other portion of job 103.

Segment 401 is received at interpreter 402, which interprets the commands in the code to redraw the object and elements of a page as vector objects 404, raster objects 406, and text objects 408. Interpreter 402 parses specific PDLs into drawing commands. The PDL of segment 401 is read and decoded into graphical elements to be placed on a sheet. Each element may be an image, a character of text, a fill, stroke, and the like or listed in vector objects 404, raster objects 406, and text objects 408.

Drawing unit 409 receives vector objects 404, raster objects 406, and text objects 408 to convert the drawing commands into metadata that can be provided to renderer 418. Thus, drawing unit 409 converts vector objects 404 into drawing services 410. It also converts raster objects 406 into graphic services 412. It also converts text objects into font rasterizer 414.

RIP 400 also may implement color converter 416. Color converter 416 may implement color conversion operations for the metadata generated by drawing unit 409. Color converter 416 provides color management and calibration. These actions may be applied during interpretation or rendering, depending on configuration and job content. Color printing resources may be accessed to provide the color management.

Renderer 418 processes the metadata from drawing unit 409 to convert every graphical element into the appropriate pattern of pixels to form the output raster. The resolution independent vector objects 404 as drawing services 410 are converted into pixels. Screening takes the raster image of pixels to form individually screened cyan, magenta, yellow, and black separations. These are halftone dots in the form of a bitmap output 420 consisting of commands that can be understood by print engine 260.

The disclosed embodiments also may determine dot count value 422 from the rendered image provided by renderer 418. Dot count values may be adjusted based on screening and based on settings at printing device 104. Dot count value 422 may be reported to determine estimate 114 for an estimation job, as disclosed below.

The rendered bitmap output 420 may be stored in storage 306 to be sent to print engine 260 when all the pages or segments of job 103 are processed. RIP 400 shows one path for rendering and providing output. Preferably, RIP 400 multiple rendering paths that use multiple renderers. The disclosed embodiments may use a renderer 418 for each channel in RIP 400, such as one each for cyan, magenta, yellow, and black. The number of renderers 418 may be configured by front end 302 depending on job 103. Each renderer 418 requires memory and processing resources. A high number of renderers 418 in RIP 400 will consume more memory but run faster. A lower number of renderers 418 in RIP 400 will consume less memory but run slower.

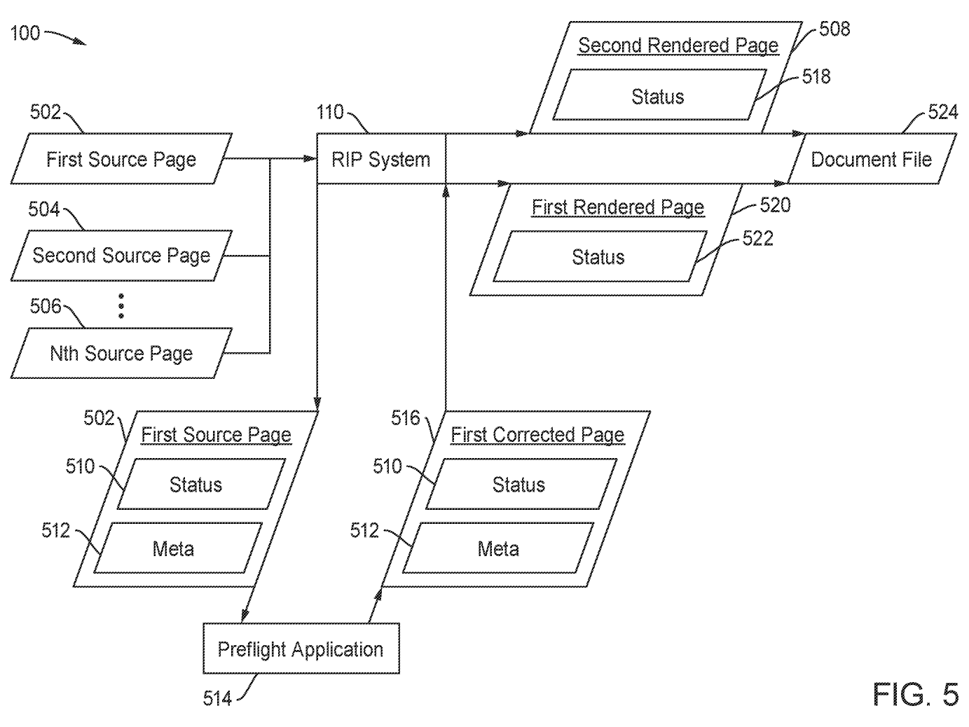

FIG. 5 depicts a block diagram of printing system 100 configured to handle rendering errors and error correction according to the disclosed embodiments. The embodiments disclosed by FIG. 5 also may be implemented in controller 106 of printing device 104. Alternatively, the embodiments may be implemented in print management server 108. Preflight application 514 may be implemented separately from the other features disclosed in FIG. 5, such as on client device 102, or another device within printing system 100.

Print job 103 may include a plurality of source pages, such as first source page 502, second source page 504, up to Nth source page 506. Print job 103 may be received in controller 106 of printing device 104 or provided to print management server 108. The respective device then provides the plurality of source pages to RIP system 110, which processes the pages to render them for printing by print engine 260. Individual pages may be distributed to the individual RIP instances of RIP system 110, as disclosed above.

RIP system 110 renders the pages as disclosed above. Some pages, however, may not be able to be rendered. One or more errors may occur during RIP processing. The disclosed embodiments separate these pages from the pages rendered normally for error handling. For example, first source page 502 may not be rendered by RIP system 110. RIP system 110 will fail first source page 502 but not print job 103. First source page 502 may include a graphic that is not able to be rendered properly, objects too close to the page edge, wrong overprint settings, forgotten spot colors, improper font size, and the like, that causes an error when rendering.

The disclosed embodiments will associate the error information with first source page 502 in status 510. Status 510 will pertain to first source page 502. The disclosed embodiments also embed metadata 512 in first source page 502 to identify the source PDL page within print job 103 at a subsequent operation. First source page 502 is then provided to preflight application 514 along with status 510 and metadata 512.

Other pages may be rendered by RIP system 110 normally and not provided to preflight application 514. For example, second source page 504 may be rendered by RIP system 110 to generate second rendered page 508. RIP system 110 also may assign status 518 to second rendered page 508 that indicates the page is ready for printing. Second rendered page 508 is placed in document file 524. Document file 524 may include the plurality of rendered pages that are ready to print and be sent to print engine 260. Preferably, the status of the rendered pages in document file 524 should be acceptable, as opposed to status 510 for first source page 502.

Once RIP system 110 is done rendering the plurality of pages from first source page 502 to Nth source page 506, the disclosed embodiments may have a set of rendered pages and set of pages that failed to render due to one or more errors. For illustrative purposes, first source page 502 represents the set of pages that failed to render and second rendered page 508 represents the set of rendered pages ready to print.

Preflight application 514 receives the pages assigned an error status and corrects the error indicated in the error information within the status. Thus, preflight application 514 opens and receives first source page 502. Status 510 indicates the error associated with first source page 502 failing to render. Preflight application 514 analyzes the contents of first source page 502 to determine its validity for print production and other conditions that may be specified by the operator. Preflight application 514 may inspect first source page 502 against a set of user-defined values, or preflight profiles. Depending on the profile, preflight application 514 also corrects errors as well as runs checks and fixups on visible areas or certain objects to make first source page 502 comply with conditions for printing at printing device 104.

Preflight application 514 may be located on a device apart from printing device 104 and controller 106. In other embodiments, preflight application 514 may be integrated directly into controller 106. In this embodiment, the operator may open first source page 502 directly in preflight application 514. In other embodiments, the operator may apply defined preflight corrections to first source page 502 in controller 106. The disclosed embodiments apply the corrections to first source page 502. This embodiment may be an integrated and automated correction process implemented in controller 106.

First corrected page 516 may be provided by preflight application 514. First corrected page 516 corresponds to first source page 502 except that the error is corrected. First corrected page 516 also include status 510 that indicates the corrected page is not ready to be placed in document file 524. Further, first corrected page 516 also includes metadata 512. Metadata 512 will be used to embed the rendered version of first corrected page 516 back into print job 103, or document file 524.

RIP system 110 receives first corrected page 516 and renders the corrected page along with any further corrected pages as they are uploaded from preflight application 514. If first corrected page 516 also fails to render due to an error, then the process may be repeated by sending the first corrected page 516 to preflight application 514 for further error correction. Preflight application 514 may resolve one error at time, for example.

At some point, a corrected page corresponding to first source page 502 is rendered without errors by RIP system 110. RIP system 110 generates first rendered page 520 that includes a status 522 which indicates the page is acceptable for printing, much like status 518 for second rendered page 508. First rendered page 520 is placed in document file 524 in the proper order based on metadata 512. Once all pages are rendered, printing system 100 or printing device 104 will print document 112 from document file 524.

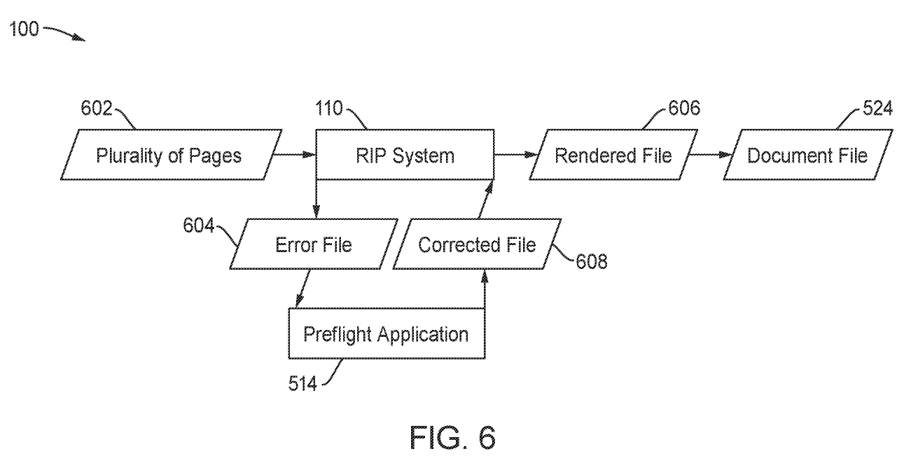

FIG. 6 depicts another block diagram of printing system 100 configured to handle rendering errors and error correction according to the disclosed embodiments. Several components disclosed in FIG. 5 are disclosed in FIG. 6. For brevity, their descriptions will not be repeated here. Print job 103 includes a plurality of pages 602. The number of pages may be 1 to any number. Plurality of pages 602 are processed by RIP system 110 as disclosed above. As disclosed above, some pages will result in errors during the rendering process while other pages will be rendered without errors.

After processing by RIP system 110, plurality of pages 602 may be split into pages having errors that are placed in error file 604. The pages not having errors that are rendered are placed into rendered file 606. Referring to FIG. 5, first source page 502 would be placed in error file 604 and second rendered page 508 would be placed in rendered file 606. For error file 604, RIP system 110, controller 106, or printing system 100 will retain information about the correlation between the pages in the error file and the source pages in plurality of pages 602.

Error file 604 is provided to preflight application 514. Preflight application 514 may download error file 604 from RIP system 110. Preflight application 514 corrects the errors on the individual pages, as disclosed above. After the corrections are made, preflight application 514 generates corrected file 608, which includes the corrected pages to be provided back to RIP system 110. For example, first corrected page 516 would be in corrected file 608.

RIP system 110 receives corrected file 608 and splits the corrected pages into single pages to replace the source pages in plurality of pages 602. RIP system 110 processes the corrected pages to be placed in rendered file 606 along with the rendered pages that did not have any errors. Any pages that still have errors even after correction will be placed in a new error file 604 to be provided back to preflight application 514. This process may be repeated until all pages are included in rendered pages 606. Rendered pages 606 then may become document file 524 to be printed.

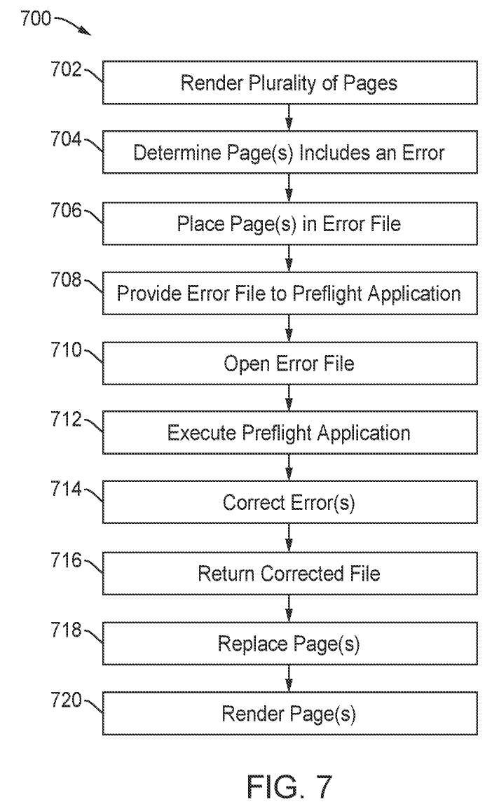

FIG. 7 depicts a flowchart 700 for handling errors during printing operations according to the disclosed embodiments. Flowchart 700 may refer to FIGS. 1-6 for illustrative purposes. Flowchart 700, however, is not limited to the embodiments disclosed by FIGS. 1-6.

Step 702 executes by rendering plurality of pages 602 at RIP system 110. Step 704 executes by determining one or more pages of the plurality of pages includes an error that fails those pages for the rendering operations. One or more pages also are rendered by RIP system 110 without errors. Step 706 executes by placing the one or more pages in error file 604. Step 708 executes by providing error file 604 to preflight application 514. Step 710 executes by opening error file 604 in preflight application 514.

Step 712 executes by executing preflight application 514 to process the pages in error file 604. Step 714 executes by correcting errors in the pages. Each page may be processed individually by preflight application 514 to correct its respective error or errors. Step 716 executes by returning the corrected pages in corrected file 608 to RIP system 110. Step 718 executes by replacing the source pages of plurality of pages 602 with the corresponding corrected pages in corrected file 608. Step 720 executes by rendering the corrected pages to be provided with the rendered pages in rendered file 606 for printing at printing device 104.

In other embodiments, flowchart 700 may be modified to send each source page having an error to preflight application 514 to correct the error. The corrected page is provided by to RIP system 110. RIP system 110 may determine a status for the different pages so that pages not having errors are rendered and pages having errors are provided to preflight application 514. Preflight application 514 corrects each page and provides the corrected pages back to RIP system 110 to be rendered.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non- exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer- usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in any combination of one or more programming languages, including an object-oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

Embodiments may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

One or more portions of the disclosed networks or systems may be distributed across one or more printing systems coupled to a network capable of exchanging information and data. Various functions and components of the printing system may be distributed across multiple client computer platforms, or configured to perform tasks as part of a distributed system. These components may be executable, intermediate or interpreted code that communicates over the network using a protocol. The components may have specified addresses or other designators to identify the components within the network.

It will be apparent to those skilled in the art that various modifications to the disclosed may be made without departing from the spirit or scope of the invention. Thus, it is intended that the present invention covers the modifications and variations disclosed above provided that these changes come within the scope of the claims and their equivalents.

1. A method for managing printing operations, the method comprising:
rendering a plurality of pages of a print job using at least one raster image processor (RIP) of a RIP system for a printing device;
determining at least one first source page of the plurality of pages includes an error that causes the at least one first source page to fail to render using the at least one RIP;
providing a data file having the at least one first source page to a preflight application;
opening the data file in the preflight application;
executing the preflight application to correct the error on the at least one first source page to generate at least one corrected page;
replacing the at least one first source page of the plurality of pages with the at least one corrected page; and
rendering the at least one corrected page using the at least one RIP of the RIP system.

2. The method of claim 1, further comprising printing the plurality of pages including the rendered at least one corrected page at the printing device.

3. The method of claim 1, wherein providing the data file includes providing the data file to the preflight application in a digital front end of the printing device.

4. The method of claim 1, wherein the providing the data file includes downloading the data file to a computing device having the preflight application.

5. The method of claim 1, further comprising setting a status for the at least one first source page to indicated that the at least one source page includes the error.

6. The method of claim 5, further comprising determining at least one second source page of the plurality of pages is rendered by the RIP of the RIP system.

7. The method of claim 6, further comprising setting a status for the at least one second source page to prevent the at least one second source page from being provided in the data file to the preflight application.

8. The method of claim 7, further comprising providing the status for the at least one first source page and the status for the at least one second source page to the RIP system.

9. The method of claim 1, further comprising compiling the at least one first source page into the data file.

10. The method of claim 1, wherein the preflight application is located within a digital front end (DFE) or controller of the printing device.

11. A method for managing printing operations, the method comprising:
rendering a print job having a plurality of pages at a raster image processing (RIP) system for a printing device;
determining a first source page of the plurality of pages includes an error by the RIP system, wherein the first source page fails to render;
opening the first source page in a preflight application associated with the printing device;
correcting the error of the first source page using the preflight application to generate a first corrected page;
replacing the first source page with the first corrected page in the plurality of pages; and
rendering the first corrected page by the RIP system.

12. The method of claim 11, further comprising embedding metadata with the first source page.

13. The method of claim 12, further comprising embedding the metadata with the first corrected page.

14. The method of claim 13, wherein replacing the first source page includes identifying the first source page to be replaced by the metadata in the first corrected page.

15. The method of claim 11, further comprising downloading the first source page to a device hosting the preflight application.

16. The method of claim 11, further comprising uploading the first corrected page from the device to the RIP system.

17. The method of claim 11, further comprising
determining a second source page of the plurality of pages does not include an error; and
rendering the second source page using the RIP system.

18. A printing system comprising:
a printing device having a raster image processing (RIP) system;
a preflight application; and
a processor connected to a memory storing instructions, wherein the processor executes the instructions to perform operations, the operations including
rendering a plurality of pages of a print job using at least one raster image processor (RIP) of the RIP system for the printing device;
determining at least one source page of the plurality of pages includes an error that causes the at least one source page to fail to render using the at least one RIP;
providing the at least one source page to the preflight application;
opening a data file of the at least one source page in the preflight application;
executing the preflight application to correct the error on the at least one source page to generate at least one corrected page;
replacing the at least one source page of the plurality of pages with the at least one corrected page; and
rendering the at least one corrected page using the at least one RIP of the RIP system.

19. The printing system of claim 18, further comprising a computing device to host the preflight application, wherein the at least one source page is downloaded to the computing device.

20. The printing system of claim 18, wherein the operations further include printing the plurality of pages at the printing device.
